(19) United States
(12) Patent Application Publication
(10) Pub. No.: US 2023/0027149 A1
(43) Pub. Date: Jan. 26, 2023

(54) Network Anomaly Control

(71) Applicant: Safedoor.ai LLC, Lake Balboa, CA (US)

(72) Inventors: Johnson Hao Wen Kuan, Azusa, CA (US); Hani Beyrouthy, Mississauga (CA); Roy Pierre Nehmeh, Lake Balboa, CA (US)

(21) Appl. No.: 17/696,621

(22) Filed: Mar. 16, 2022

Related U.S. Application Data
(60) Provisional application No. 63/162,384, filed on Mar. 17, 2021.

(51) Int. Cl. H04L 9/40

(52) U.S. Cl. CPC H04L 63/1441; H04L 63/1425; H04L 63/20

(57) ABSTRACT

Systems and techniques for network anomaly control are described to detect, identify, and control anomalous data within network communication. Network data is encoded into a vector representation of a session, and the vector representation of the session is decoded into reconstructed network data. The network data and the reconstructed network data are utilized to identify malicious data, and control actions may be performed such as to control or remove the malicious data or to disallow network access to entities associated with the malicious data.

### RELATED APPLICATIONS

This application claims priority to U.S. Provisional Application No. 63/162,384, filed Mar. 17, 2021, entitled “Network Anomaly Detection”, the disclosure of which is incorporated by reference herein in its entirety.

### BACKGROUND

With the evolution of Internet and digital technology, more people are consuming a wide variety of online content (e.g., web pages, social media, documents, data, applications, services, images, media, files, and so forth). Online content is being served to users on a multitude of environments ranging from desktop computers to mobile devices (e.g., cell phones, wearable devices) connected to a network. Many everyday tasks in every aspect of life now involve the transmission of data over a network. Average home consumers can receive terabytes of data each month, while organizational consumers often receive terabytes, petabytes, or even more data each month. While the vast majority of this data is benign, a portion of it includes malicious data that is detrimental to users of the network, for example malicious data configured to grant control of a computing system to an unintended third party, discretely gain access to view files on a computing system, and so forth. Accordingly, it is desirable to identify malicious data in an expedient manner.

Conventional techniques used to identify malicious data, however, are faced with numerous challenges that limit accuracy of the techniques as well as involve inefficient use of computation resources. In one example, conventional techniques for network and computing security are reactive in nature to new threats. Conventional techniques may require malicious data to have successfully caused harm before the malicious data is detected through a postmortem analysis of the compromised system. Once a new threat has been detected in this manner, conventional techniques to counteract the new threat on other systems may then subsequently be determined, created, and employed. Thus, conventional techniques for identifying or counteracting malicious data cannot provide protection against new or previously undetected threats.

Further, conventional techniques rely upon expensive manually designed features for a particular type of malicious data, and features carefully designed for one type are inapplicable to other types. Manually designed features are highly sensitive to noise or missing values. Therefore, these conventional techniques have limited accuracy and result in inefficient use of computational resources by systems that employ these conventional techniques.

### SUMMARY

Systems and techniques for network anomaly control are described to detect, identify, and control anomalous data within network communication. These techniques overcome the limitations of conventional malicious data detection systems which are limited to manually designed detection for known types of malicious data. To do so, the network anomaly control techniques described herein leverage insights gained from “big data” to determine a degree to which input data conforms to general characteristics of benign data. The characteristics of benign data are harvested from a large quantity of sample data that includes benign data, and a model is trained to encode and subsequently decode benign data to produce reconstructed output data corresponding to the input data.

Once trained, new data is input into the model, and the model encodes the new data into a session vector and subsequently decodes the session vector into output data based on an assumption that the input data is benign. In scenarios where the input data is benign, this process results in output data similar to the input data. However, in scenarios where the input data is malicious, the assumption that the input data is benign causes significant reconstruction error in the decoding process and the output data has large differences when compared to the input data. Differences between corresponding input and output data are used to identify anomalies within network data that correspond to malicious data. Once identified, the systems described herein may then initiate actions pertaining to the malicious data such as to control or remove the malicious data.

By assuming that input data is benign, and utilizing reconstruction error from the encoding and decoding process as an indicator of non-benign or malicious data, the network anomaly control techniques described herein may evaluate a wide range of data beyond what is capable of being addressed by conventional techniques. The network anomaly control techniques allow for malicious data to be identified and controlled for any type of malicious data, whether previously known or undetected, thereby increasing the scope of protection against a broader range of threats than conventional techniques are capable of providing. Further, as the network anomaly control techniques are operable against previously unseen forms of malicious data, the techniques described herein do not suffer from the “lag time” inherent in conventional techniques following discovery of a new form of malicious data, and systems employing the network anomaly control techniques do not require modifications or updates to incorporate new detection methods every time a new form of malicious data is discovered.

This summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ network anomaly control techniques as described herein.

FIG. 2 depicts an example system showing a digital analytics processing pipeline of the digital analytics system of FIG. 1 in greater detail.

FIG. 3 depicts an example system showing usage of the input reconstruction model of FIG. 1 in greater detail.

FIG. 4 depicts an example system showing a machine learning processing pipeline of the machine learning module of FIG. 1 in greater detail.

FIG. 5 depicts an example system showing a reconstruction processing pipeline of the input reconstruction module of FIG. 1 in greater detail.

FIG. 6 depicts an example system showing an anomaly prediction processing pipeline of the anomaly prediction system of FIG. 1 in greater detail.

FIG. 7 depicts an example system showing a security application processing pipeline of the security application of FIG. 1 in greater detail.

FIG. 8 depicts an example user interface of a computing device employing the techniques described herein.

FIG. 9 depicts an example visualization of session embedding values.

FIG. 10 depicts an example visualization of anomaly scores for bytes within a packet.

FIG. 11 is a flow diagram depicting a procedure in an example implementation of network anomaly control techniques.

FIG. 12 illustrates an example system including various components of an example device that can be implemented as any type of computing device as described and/or utilized with reference to FIGS. 1-11 to implement embodiments of the techniques described herein.

### DETAILED DESCRIPTION

Overview

In conventional systems for network protection, techniques are derived to combat known attack methods and to counteract known forms of malicious data. However, such conventional techniques are reactive and operable only against known threats that utilize specific data formats. Thus, conventional techniques require malicious data to have performed harm and been detected and analyzed before network protection techniques can be tailored to address the threat. Further, as conventional techniques must be manually tailored for specific types of malicious data, they require expensive manual features designed by cybersecurity experts.

Accordingly, techniques are described in which anomalous data within network communication is detected, identified, and controlled by a network anomaly control system. To do so, the network anomaly control techniques determine a degree to which input data conforms to general characteristics of benign data. The characteristics of benign data are harvested from a large quantity of sample data that includes benign data, and a machine learning model is trained to encode and subsequently decode benign data to produce reconstructed output data corresponding to the input data. The machine learning model, for example, includes a neural network that produces a session vector at a bottleneck layer, the session vector representing an entire session of network data.

Once trained, new data is input into the model, and the model encodes the new data into a session vector and subsequently decodes the session vector into reconstructed output data based on an assumption that the input data is benign. This may include, for instance, encoding the new data into byte vectors, encoding the byte vectors into packet vectors, encoding the packet vectors into a session vector, decoding the session vector into reconstructed packet vectors, and decoding the reconstructed packet vectors into reconstructed byte vectors. In scenarios where the input data is benign, this process results in reconstructed output data similar to the input data. In the ongoing example, the reconstructed byte vectors are similar to the byte vectors if the input data is benign. However, in scenarios where the input data is malicious, the assumption that the input data is benign causes inaccuracies in the decoding process and the reconstructed output data has large differences when compared to the input data. Differences between corresponding input and reconstructed output data are used to identify anomalies within network data that correspond to malicious data. For example, a degree in difference between values in the byte vectors and the reconstructed byte vectors are indicative of a likelihood that the corresponding byte is associated with malicious data or malicious behavior. Once malicious data is identified, the systems described herein may then initiate actions pertaining to the malicious data such as to control or remove the malicious data.

By assuming that input data is benign, and utilizing reconstruction error from the encoding and decoding process as an indicator of non-benign or malicious data, the network anomaly control techniques described herein may evaluate a wide range of data beyond what is capable of being addressed by conventional techniques. The network anomaly control techniques allow for malicious data to be identified and controlled for any type of malicious data, whether previously known or undetected, thereby increasing the scope of protection against a broader range of threats than conventional techniques are capable of providing. Further, as the network anomaly control techniques are operable against previously unseen forms of malicious data, the techniques described herein do not suffer from the “lag time” inherent in conventional techniques following discovering of a new form of malicious data, and systems employing the network anomaly control techniques do not require modifications or updates to incorporate new detection methods every time a new form of malicious data is discovered.

Additionally, conventional techniques for network security may require a user to grant access to network data to a third party, which compromises the privacy of sensitive data. The network anomaly control techniques described herein, in contrast, may be performed by ‘edge’ devices or client devices on a local network without transmitting or reproducing network data outside of the local network. For example, while a machine learning model utilized by the network anomaly control techniques is trained by a computing device outside of local network, such as on a server or ‘in the cloud’, an instance of the trained model is executed on a computing device within the local network and in control of the end-user, which may then process the end-user's network data without communicating such network data outside of the end-user's computing device or outside of the local network.

In this way, the network anomaly control techniques may be generalized to a wide range of events, beyond what may be addressed by conventional network security techniques. Accuracy of detection is increased by eliminating the need to reactively respond to known threats. As a result, systems utilizing the network anomaly control techniques described herein are provided with increased protection and improved operation efficiency of a computing device that employs these techniques, and privacy is maintained for a user of a computing device that employs these techniques.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

### Example Environment

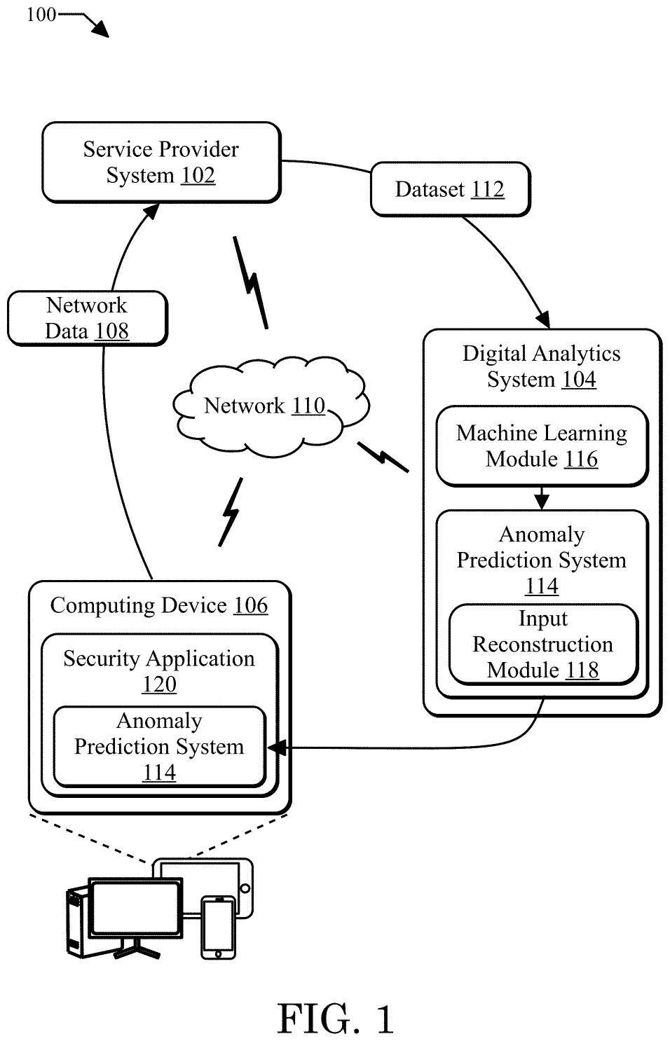

FIG. 1 is an illustration of a digital medium environment 100 in an example implementation that is operable to employ network anomaly control techniques as described herein. The illustrated environment 100 includes a service provider system 102, a digital analytics system 104, and a plurality of computing devices, an example of which is illustrated as computing device 106. In this example, network data 108 is generated when the computing device 106 communicates via a network 110, such as communication with the service provider system 102. The service provider system 102, the digital analytics system 104, and the computing devices 106 are communicatively coupled, one to another, via the network 110 and may be implemented by a computing device that may assume a wide variety of configurations.

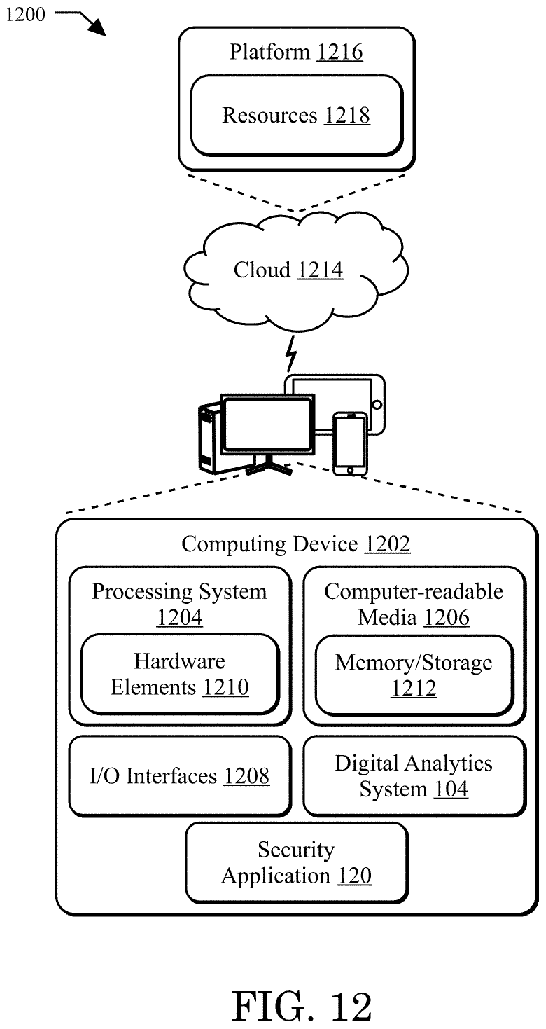

A computing device, for instance, may be configured as a desktop computer, a laptop computer, a mobile device (e.g., with a handheld configuration such as a mobile phone or a tablet, a wearable device such as a watch), and so forth. A computing device may also, for instance, be configured as a network router, a modem, a smart-home device, or any hardware device connected to the network 110. Thus, the computing device may range from full resource devices with substantial memory and processor resources (e.g., personal computers or game consoles) to a low-resource device with limited memory and/or processing resources (e.g., mobile devices, routers). Additionally, although a single computing device is shown, a computing device may be representative of a plurality of different devices, such as multiple servers utilized by a business to perform operations as part of a cloud computing implementation as shown for the service provider system 102 and the digital analytics system 104 and as further described in FIG. 12.

The network data 108 describes data communicated to or from the computing device 106 via the network 110. For example, the network data 108 may include data communicated between the computing device 106 and the service provider system 102. A dataset 112 is generated based on various network data 108 (e.g., from multiple sessions, from multiple computing devices 106, from sessions between a computing device 106 and various other computing devices, and so forth).

The dataset 112 is received by the digital analytics system 104, which in the illustrated example employs this data to generate an anomaly prediction system 114. To do so, the digital analytics system 104 utilizes a machine learning module 116 to generate a machine learning model, such as an input reconstruction module 118, as a part of the anomaly prediction system 114. The anomaly prediction system 114, for instance, may be used to predict whether anomalous or malicious activity is occurring based on input network data, such as based on an observation obtained from the computing device 106. As an example, the anomaly prediction system 114 may receive as an input the network data 108, and may employ the input reconstruction module 118 to identify anomalous bytes within the network data 108.

As an example, the input reconstruction module 118 may be configured to encode bytes of the network data 108 into a session vector representation and decode the session vector representation into bytes. The input reconstruction module 118 is configured to produce output reconstructed bytes that are similar to corresponding input bytes, utilizing an assumption that the input bytes pertain to benign data. The anomaly prediction system 114 utilizes the output reconstructed bytes to identify anomalous or malicious bytes in the network data 108.

The anomaly prediction system 114 and the input reconstruction module 118, once trained, may be included as part of a security application 120. The security application 120 may be implemented on at least one of the service provider system 102, the digital analytics system 104, and the computing device 106. The security application 120 is configured to monitor the network data 108 and input the network data 108 into the anomaly prediction system 114. In this example, the input reconstruction module 118 generates reconstructed network data corresponding to the network data 108. The anomaly prediction system 114 then generates anomaly scores or reconstruction errors representing a likelihood that a packet of network data in the network data 108 includes anomalous or malicious activity. Upon detection of anomalous or malicious activity, the security application 120 may perform various actions pertaining to the anomalous activity, such as sending a notification to a user device with information describing the anomalous activity, blocking an IP address or MAC number associated with a source of the anomalous activity, temporarily closing network ports being attacked by the anomalous activity, and so forth. It is to be appreciated that the anomaly prediction system 114 and/or the security application 120 may be deployed on a computing device 106 different than the computing device 106 associated with the network data 108 included in the dataset 112, and the network data 108 included in the dataset 112 may be different than the network data 108 monitored by the security application 120.

In implementations, the security application 120 is deployed on a computing device 106 that is an ‘edge device’ or which consumes edge computing resources. An edge device refers to a computing device that is at or behind a boundary between two networks. For example, an edge device at a boundary between two networks is a router connecting a local network to the internet or a wide area network, which serves as a gateway between the networks, or a firewall device on the periphery of a local network that filters data entering or leaving the local network. However, an edge device may also refer to computing devices in a local network that is behind a boundary between two networks, such as a computing device in a local network that is connected to a router or gateway which in turn is connected to the internet or a wide area network. Edge computing resources generally refers to utilizing computing resources available within a local network. For example, the security application 120 on a computing device 106 may employ edge computing to utilize only computing resources available within the computing device 106 itself or within a local network that includes the computing device 106.

By utilizing edge computing resources or by being implemented on an edge device, the security application 120 processes and monitors network data of a local network without exporting the network data outside of the local network. In doing so, the security application 120 maintains data privacy of the local network and users of the local network. By identifying malicious data within a local network, the security application 120 may then communicate information pertaining to the malicious data, or the malicious data itself, to other computing devices or networks without compromising the privacy of non-malicious data.

Conventional network security techniques fail when confronted with new or unseen security threats. For instance, conventional network security techniques are created to react to known and specified forms of threats, with manually curated detection techniques and responses tailored to those known threats. Further, conventional network security techniques require strong expert knowledge to manually identify new or unseen security threats, require a time-lag between initial identification of new threats and deploying a solution to counteract the newly identified threats, and may violate privacy of users of the conventional techniques.

Accordingly, in the techniques described herein, a network anomaly control technique is implemented to leverage machine learning to classify network activity in a manner that identifies malicious activity without any prior knowledge or identification of the type of malicious activity being performed, providing techniques for identifying and controlling malicious activity in real-time or near real-time for a wide range of events (such as any malicious activity, whether or not the activity has been previously seen or identified), which is not possible in conventional network security techniques. To do so, anomaly detection techniques utilize an anomaly prediction model to compress packets of internet session data into a single vector representation and decompress the single vector representation into reconstructed packets of internet session data. The security application 120 may perform a comparison between the packets and the reconstructed packets to identify packets including anomalous or malicious activity, and may leverage the identified packets to initiate further processes such as providing a user of the computer device 106 with network control options to control the identified packets. In this way, the network anomaly control techniques described herein may be used to overcome limitations of conventional techniques, and thus enhance network security as well as provide an improved user experience (i.e., flexibility for the user to decide what action to take regarding threats or alerts, enabling preservation of data privacy, and so forth) on computing devices that employ these techniques.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

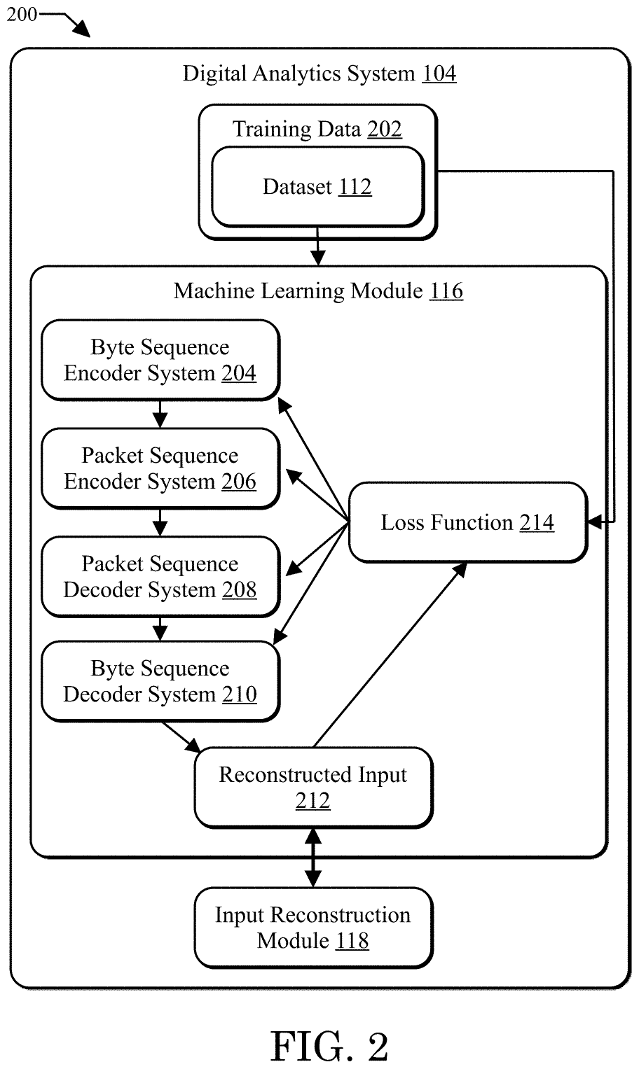

FIG. 2 depicts a system 200 showing an example digital analytics processing pipeline of the digital analytics system 104 of FIG. 1 in greater detail to create the input reconstruction module 118. In implementations, the digital analytics system 104 employs the machine learning module 116 to create the input reconstruction module 118. The digital analytics processing pipeline begins with creation of training data 202, which is input to the machine learning module 116.

The training data 202 includes raw bytes of data from packets in an internet session, and includes benign data. In implementations, the training data 202 does not include malicious data. It is to be appreciated that in other implementations, the training data also includes malicious activity (e.g., to negatively reinforce identification of benign activity). For example, a PCAP file is sessionized to get a sequence of packets for each session (e.g., TCP, UDP sessions). The training data 202 may include data pertaining to multiple sessions of internet data, with each session including a sequence of packets, and each packet including a sequence of bytes. The session data may be converted to hex strings to represent respective sequences of bytes in respective packets, although any format may be utilized to represent the session data (e.g., raw binary data). The batch size may then be configured to control the number of packets per batch of data used for input to the machine learning module. In another implementation, the training data 202 is represented by highly aggregated statistics of respective sessions, and does not include sequences of bytes.

The training data 202 is input to the machine learning module 116 to create the input reconstruction module 118. In implementations, the sequences of bytes in each packet are converted into vectors or tensors by utilizing an embedding lookup layer within the machine learning module 116 with randomly initialized weights that are trainable model parameters. In the illustrated example, the machine learning module 116 utilizes an unsupervised encoder-decoder architecture, and employs a byte sequence encoder system 204, a packet sequence encoder system 206, a packet sequence decoder system 208, and a byte sequence decoder system 210 as different respective layers of a neural network as described in greater detail below.

By analyzing features of the training data 202 (e.g., at various levels of abstraction or depths within layers of a neural network) the input reconstruction module 118, when given a subsequent input, generates a reconstructed input 212. The input reconstruction module 118, when provided with the training data 202 as an input, thus creates a reconstructed input 212 corresponding to the input training data 202. In implementations, the reconstructed input 212 may be in a vector or tensor format corresponding to vector or tensor representations of the training data 202, such as vector or tensor representations of the training data 202 created by an embedding lookup layer of the machine learning module 116. In other implementations, the reconstructed input 212 may be in a hexadecimal or binary format corresponding to raw data within the training data 202.

To verify the accuracy of the reconstructed input 212, the machine learning module 116 compares the reconstructed input 212 with the corresponding correct values in the training data 202. In implementations, the model is trained by feeding batches of data one at a time, and one epoch of training includes each batch of data. After each batch, trainable weights in the machine learning module 116 are updated. For instance, the machine learning module 116 can determine the differences between the reconstructed input 212 and the actual input values in the training data 202 by utilizing a loss function 214 to determine a measure of loss (i.e., a measure of difference such as a mean square error or mean absolute loss). As an example, the loss function 214 can determine a measure of loss for each byte of data between an input byte and a corresponding reconstructed byte, can determine a measure of loss for each packet, can determine a measure of loss for each internet session, and so forth.

The machine learning module 116 uses the loss function 214 (e.g., uses the measure of loss resulting from the loss function 214) to train the input reconstruction module 118. In particular, the machine learning module 116 can utilize the loss function 214 to correct parameters or weights in the machine learning module 116 that resulted in inaccurate values for the reconstructed input 212. The machine learning module 116 can use the loss function 214 to modify one or more functions or parameters to minimize the loss function 214 and reduce the differences between the reconstructed input 212 and the correct values in the training data 202 in subsequent epochs of training. In this way, the machine learning module 116 may employ the loss function 214 to learn the input reconstruction module 118 through processing of the training data 202.

In implementations, a plurality of different loss functions 214 may be employed within the machine learning module, for instance a different loss function 214 for each of the byte sequence encoder system 204, the packet sequence encoder system 206, the packet sequence decoder system 208, and the byte sequence decoder system 210. In other implementations, a single loss function 214 may be employed that incorporates values from multiple layers within the neural network. Once trained, the input reconstruction module 118 may then be used as part of the anomaly prediction system 114 to perform classifications, segmentations, predictions, and so forth.

As described above, the machine learning module 116 can train the input reconstruction module 118 using the training data 202 derived from the dataset 112. Although described above as utilizing an unsupervised encoder-decoder architecture, the machine learning module 116 can use any suitable machine learning techniques. According to various implementations, the machine learning module 116 uses supervised learning, unsupervised learning, or reinforcement learning. For example, the machine learning module 116 can include, but is not limited to, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. In any case, the machine learning module 116 uses machine learning techniques to continually train and update the input reconstruction module 118 to produce accurate reconstructions of input data given a subsequent input.

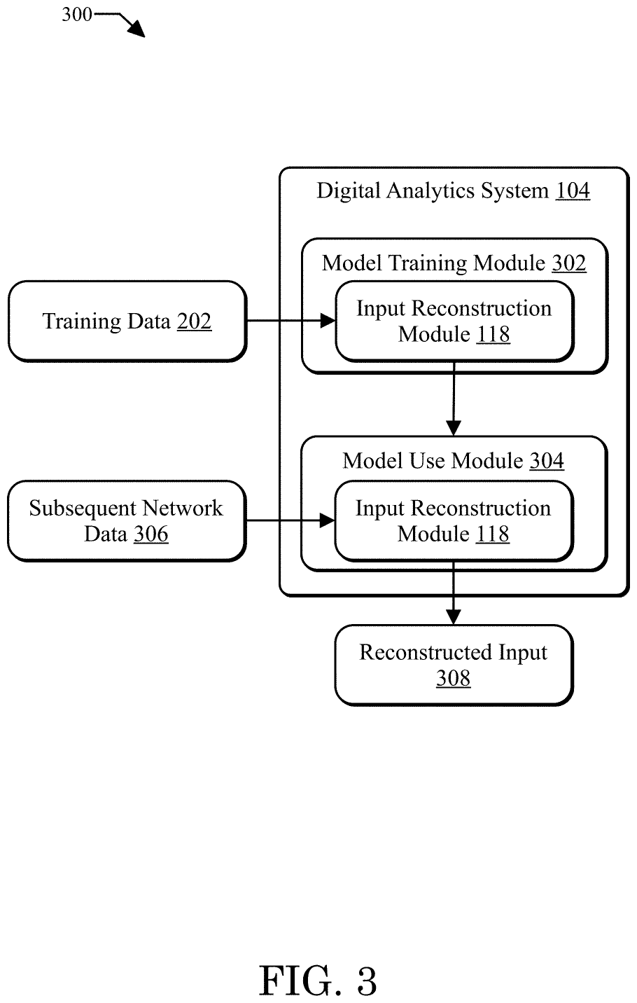

As shown in system 300 of FIG. 3, the input reconstruction module 118 once trained, may be passed from a model training module 302 (e.g., the machine learning module 116 of FIG. 1) to a model use module 304. The model use module 304 receives subsequent network data 306. Using the trained input reconstruction module 118, a reconstructed input 308 is generated based on the subsequent network data 306. The reconstructed input 308 is then output, e.g., for comparison by the anomaly prediction system 114 or security application 120 with the corresponding input to generate an anomaly score (e.g., a representation of reconstruction error) and control subsequent output of digital content (e.g., for display in a user interface and so forth) or control the subsequent network data 306.

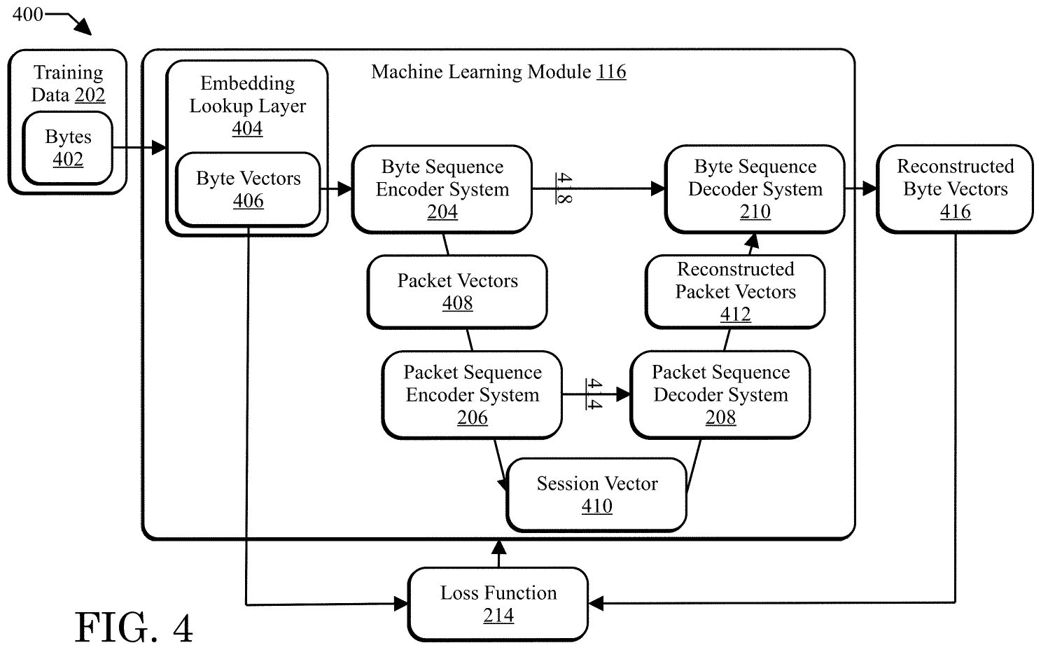

FIG. 4 depicts a system 400 showing an example machine learning processing pipeline of the machine learning module 116 of FIG. 1 in greater detail to create the input reconstruction module 118. The machine learning processing pipeline begins with the training data 202 being input to the machine learning module 116. The training data includes bytes 402 of network data, such as raw hexadecimal bytes.

The bytes 402 are processed by an embedding lookup layer 404 to generate byte vectors 406. The byte vectors 406 are representative of corresponding bytes 402, and may be represented according to various formats such as vectors or tensors. The embedding lookup layer 404 is representative of a layer of a neural network, and implementations the embedding lookup layer 404 includes randomly initialized weights that are trainable model parameters.

The byte sequence encoder system 204 represents a layer of a neural network that converts the byte vectors 406 into packet vectors 408. A single one of the packet vectors 408 is representative of multiple corresponding ones of the byte vectors 406. For instance, a single packet vector 408 may be created to represent a packet of the byte vectors 406, and multiple packet vectors 408 may be created each representing a corresponding packet of the byte vectors 406. The byte sequence encoder system 204 may be implemented, for example, as a layer of a recurrent neural network, and may include a randomly initialized hidden state that includes trainable model parameters.

The packet sequence encoder system 206 represents a layer of a neural network that converts the packet vectors 408 into a session vector 410 representing the packet vectors 408. For instance, a single session vector 410 is created to represent multiple packet vectors 408 (e.g., all packet vectors 408 corresponding to a session) which in turn represent multiple packets each containing sequences of byte vectors 406. A single session vector 410, for example, may represent an entire session of internet session data. The packet sequence encoder system 206 may be implemented, for example, as a layer of a recurrent neural network, and may include a randomly initialized hidden state that includes trainable model parameters.

The packet sequence decoder system 208 represents a layer of a neural network that converts the session vector 410 into reconstructed packet vectors 412. The packet sequence decoder system 208 may be implemented, for example, as a layer of a recurrent neural network, and may include a randomly initialized hidden state that includes trainable model parameters. In implementations, the neural network utilizes packet skip connections 414. The packet skip connections 414 enable information from a prior layer of the neural network to be included as an input to the packet sequence decoder system 208 in addition to the input of the session vector 410. In implementations, the packet skip connections 414 enable the packet vectors 408 to be included as an input to the packet sequence decoder system 208. The reconstructed packet vectors 412 correspond to respective ones of the packet vectors 408, and the packet sequence decoder system 208 may create multiple reconstructed packet vectors 412 from a single session vector 410.

The byte sequence decoder system 210 represents a layer of a neural network that converts the reconstructed packet vectors 412 into reconstructed byte vectors 416. The byte sequence decoder system 210 may be implemented, for example, as a layer of a recurrent neural network, and may include a randomly initialized hidden state that includes trainable model parameters. In implementations, the neural network utilizes byte skip connections 418. The byte skip connections 418 enable information from a prior layer of the neural network to be included as an input to the byte sequence decoder system 210 in addition to the input of the reconstructed packet vectors 408. In implementations, the byte skip connections 418 enable the byte vectors 406 to be included as an input to the byte sequence decoder system 210. The reconstructed byte vectors 416 correspond to respective ones of the byte vectors 406, and the byte sequence decoder system 210 may create multiple reconstructed byte vectors 416 from a single reconstructed packet vector 412.

In implementations, the byte sequence encoder system 204, the packet sequence encoder system 206, and the byte sequence decoder system 210, are representative of recurrent neural network layers, while the packet sequence decoder system 208 is representative of a fully connected neural network layer.

In implementations, the machine learning module 116 may include a dimensionality neural network layer following the byte sequence decoder system 210. For example, the dimensionality neural network layer may be a fully connected neural network layer configured to ensure that the reconstructed byte vectors 416 have a dimensionality corresponding to a dimensionality of the byte vectors 406, and the dimensionality neural network layer may include a randomly initialized hidden state that includes trainable model parameters. It is to be appreciated that any suitable technique may be utilized to convert the dimensionality of the output of the byte sequence decoder system 210 to match a dimensionality of the byte vectors 406.

The machine learning module 116 thus represents functionality to compress or encode bytes of data from multiple sequences of packets of an internet session into a single compressed dense vector representation of the session, and to decompress or decode the dense vector representation into reconstructed bytes of data for multiple reconstructed packets of a reconstructed internet session. In implementations, the machine learning module 116 utilizes an unsupervised learning model that does not require target labels for training.

In implementations, the machine learning module 116 may utilize only portions of the method described above. For example, in implementations the machine learning module 116 includes the byte sequence encoder system 204 and the packet sequence encoder system to provide an output of the session vector 410, but does not include the packet sequence decoder system 208 or the byte sequence decoder system 210. In other implementations, the machine learning module 116 includes as output both the session vector 410 and the reconstructed byte vectors 416, and so forth.

In another implementation, the machine learning module 116 includes a session sequence encoder system that directly encodes the byte vectors 406 into the session vector 410, replacing both the byte sequence encoder system 204 and the packet sequence encoder system 206. In this example, the machine learning module 116 further includes a session sequence decoder system that directly decodes the session vector 410 into the reconstructed byte vectors 416, replacing both the packet sequence decoder system 208 and the byte sequence decoder system 210. In yet another implementation, the machine learning module 116 includes additional layers in a neural network beyond those illustrated in FIG. 4.

The session vector 410, when provided as an output of the machine learning module 116, may be utilized, for example, to train a supervised machine learning model to classify types of attacks for a session (e.g., brute force attack, web attack, denial of service attack, and so forth). A supervised machine learning model may be trained, for instance, using training data with target labels of the type of attack. In this implementation, the session vector 410 represents latent features used to classify the type of attack.

The machine learning module 116 seeks to minimize the difference between the reconstructed byte vectors 416 and the corresponding byte vectors 406. To do so, the machine learning module 116 utilizes an iterative process to adjust trainable functions or parameters that affect the output of the machine learning module 116. For instance, after each epoch of training, the byte vectors 406 and the reconstructed byte vectors 416 are input to the loss function 214. For each corresponding pair of byte vector 406 and reconstruction byte vector 416, the loss function 214 may determine a measure of loss and modify one or more functions or parameters used within the machine learning module 116 in an effort to further minimize the measure of loss of future epochs. In this way, the machine learning module 116 employs the loss function 214 to iteratively learn and update functions or parameters utilized within the machine learning module 116. In an example, there are separate parameters or functions corresponding to each of the embedding lookup layer 404, the byte sequence encoder system 204, the packet sequence encoder system 206, the packet sequence decoder system 208, and the byte sequence decoder system 210, and the machine learning module 116 updates each of these corresponding parameters or functions with each epoch.

The machine learning module 116 may perform this iterative process for any number of epochs of training, in an effort to generate trained parameters capable of producing reconstructed byte vectors 416 as close as possible to the corresponding byte vectors 406. When training is completed, the machine learning module 116 outputs the trained input reconstruction module 118, which may include the trained embedding lookup layer 404, the trained byte sequence encoder system 204, the trained packet sequence encoder system 206, the trained packet sequence decoder system 208, and the trained byte sequence decoder system 210, each including the trained parameters or functions including the values produced by the final epoch of training by the machine learning module 116. Once output from the machine learning module 116, the input reconstruction module 118 may exist independent and external to the machine learning module 116, and is no longer iteratively updated unless a new training process is performed by the machine learning module 116.

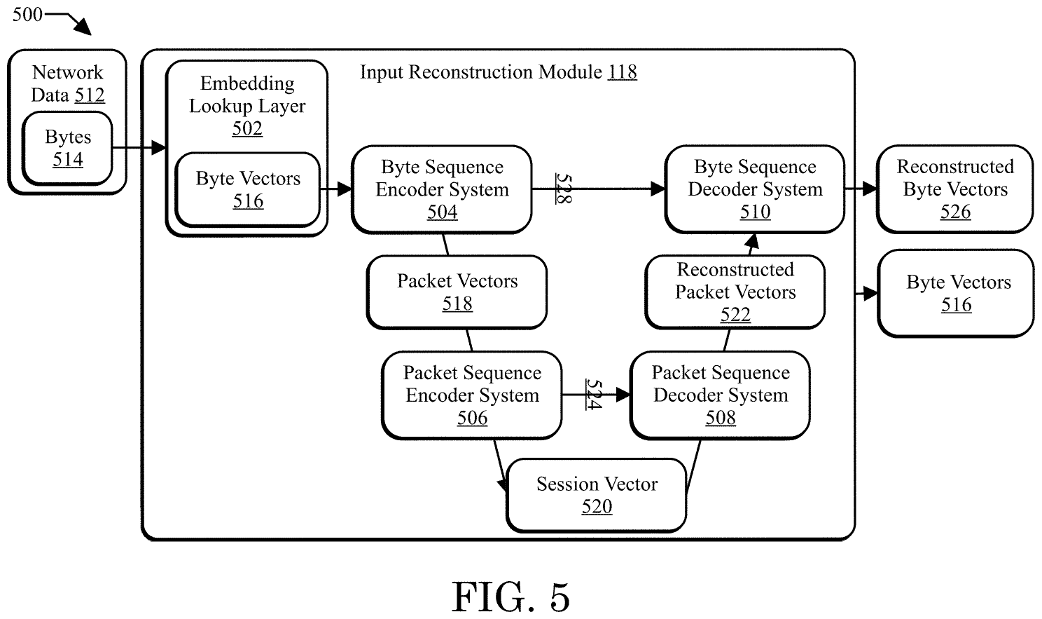

FIG. 5 depicts a system 500 showing an example reconstruction processing pipeline of the input reconstruction module 118 of FIG. 1 in greater detail to generate a reconstructed input. In this example, the input reconstruction module 118 includes the embedding lookup layer 502, the trained byte sequence encoder system 504, the trained packet sequence encoder system 506, the trained packet sequence decoder system 508, and the trained byte sequence decoder system 510, each including the trained parameters or functions including the values produced by the final epoch of training by the machine learning module 116 as described above with respect to FIG. 4 for respective ones of the embedding lookup layer 404, the byte sequence encoder system 204, packet sequence encoder system 206, packet sequence decoder system 208, and byte sequence decoder system 210.

Network data 512 is input to the input reconstruction module 118, such as bytes 514 generated or processed from among the network data 512. The network data 512 may be, for instance, the network data 108 of FIG. 1. In this example, the network data 512 is unknown data, and may include both benign and malicious data. The bytes 514 are converted by the trained embedding lookup layer 502 to generate corresponding byte vectors 516. Sequences of the byte vectors 516 are converted by the trained byte sequence encoder system 504 into respective packet vectors 518. The trained byte sequence encoder system 504 does so by utilizing the trained functions and parameters learned by the machine learning module 116 as described above with respect to FIG. 4. While the byte sequence encoder system 204 utilized by the machine learning module 116 of FIG. 4 includes randomly initialized and iteratively updated parameters and functions, the trained byte sequence encoder system 504 includes static parameters and functions corresponding to a final epoch of training for the sequence encoder system 204.

Respective sequences of the packet vectors 518 are converted by the trained packet sequence encoder system 506 into a session vector 520. The trained packet sequence encoder system 506 does so by utilizing the trained functions and parameters learned by the machine learning module 116 as described above with respect to FIG. 4. While the packet sequence encoder system 206 utilized by the machine learning module 116 of FIG. 4 includes randomly initialized and iteratively updated parameters and functions, the trained packet sequence encoder system 506 includes static parameters and functions corresponding to a final epoch of training for the packet sequence encoder system 206. The session vector 520 may represent an entire session of the network data 512, and represents the bottleneck layer of the input reconstruction module 118.

The session vector 520 is converted by the trained packet sequence decoder system 508 into reconstructed packet vectors 522. In implementations, the trained packet sequence decoder system 508 also receives as an input the packet vectors 518 via a skip connection 524 between the packet sequence encoder system 506 and the packet sequence decoder system 508. The reconstructed packet vectors 522 are converted by the trained byte sequence decoder system 510 into reconstructed byte vectors 526. In implementations, the trained byte sequence decoder system 510 also receives as an input the byte vectors 516 via a skip connection 528 between the byte sequence encoder system 504 and the byte sequence decoder system 510. While the packet sequence decoder system 208 and byte sequence decoder system 210 utilized by the machine learning module 116 of FIG. 4 includes respective randomly initialized and iteratively updated parameters and functions, the trained packet sequence decoder system 508 and the trained byte sequence decoder system 510 include respective static parameters and functions corresponding to a final epoch of training by the machine learning module 116.

In this way, the input reconstruction module 118 receives as an input unknown network data 512, and generates an output of the byte vectors 516 and the reconstructed byte vectors 526. As the input reconstruction module 118 was created and trained based on training data of normal or benign network activity (e.g., activity between a client and a server on the internet) in order to recreate benign network activity, it produces accurate reconstructed byte vectors 526 when the bytes 514 correspond to normal or benign network activity. However, for input network data 512 that includes malicious or non-benign bytes 514, the corresponding reconstructed byte vectors 526 generated by the input reconstruction module 118 are inaccurate and include substantial differences compared to the corresponding byte vectors 516.

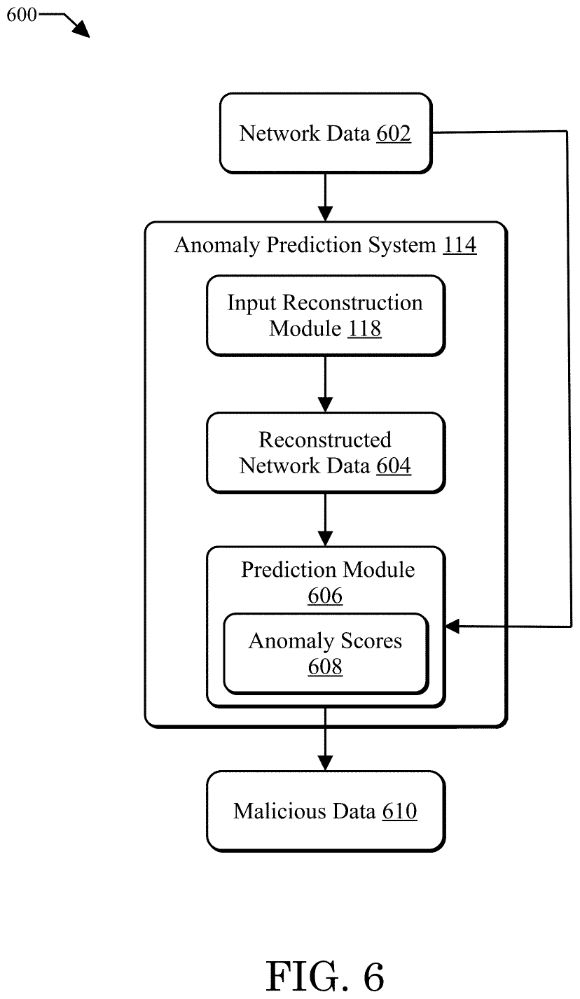

FIG. 6 depicts a system 600 showing an example anomaly prediction processing pipeline of the anomaly prediction system 114 of FIG. 1 in greater detail to identify anomalous or malicious data. The anomaly prediction processing pipeline begins with an input of network data 602 into the anomaly prediction system 114.

The network data 602 may include raw bytes of data from packets in an internet session, the contents of which are unknown and may include any combination or amounts of benign and/or malicious data. In implementations, the network data 602 is sessionized to get a sequence of packets for each session (e.g., TCP, UDP sessions), and the session data is converted to hex strings to represent a sequence of bytes in each packet.

The anomaly prediction system 114 may filter or truncate the network data 602 to reduce the quantity of bytes available for further processing. For instance, the anomaly prediction system 114 may truncate the network data 602 to maintain a number of initial or leading bytes at the start of each session or packet, while discarding bytes that are not leading bytes. As an example, the anomaly prediction system 114 may truncate a stream of network data being received from a streaming video provider to result in an analysis of leading bytes from the stream, without analyzing the entirety of the video stream. The anomaly prediction system 114 may further filter the network data 602, such as to ‘white-list’ particular sources of network data that are known to be safe, and thus reduce the computational budget required by the anomaly prediction system 114.

Once the network data 602 has been pre-processed in this manner, the resulting data is input to the input reconstruction module 118. The input reconstruction module 118 may, for instance, convert each respective sequence of bytes in the network data 602 into tensors (e.g., a set of vectors) by utilizing an embedding lookup layer. As described above with respect to FIG. 5, the input reconstruction module 118 generates reconstructed network data 604 corresponding to the network data 602. In implementations, the anomaly prediction system 114 includes a prediction module 606 that assigns respective anomaly scores 608 to portions of the network data 602. To do so, the anomaly prediction system 114 compares corresponding portions of the network data 602 and the reconstructed network data 604 (e.g., a byte and a reconstructed byte, a byte vector and a reconstructed byte vector, and so forth). For example, a large difference between a byte vector of reconstructed network data 604 and a corresponding byte vector of the network data 602 results in a large anomaly score 608 for the byte vector of the network data 602, and a small difference between a byte vector of reconstructed network data 604 and a corresponding byte vector of the network data 602 results in a small anomaly score 608 for the byte vector of the network data 602. The anomaly score 608 for a portion of the network data 602 indicates whether the portion of the network data 602 is an anomaly, and is representative of a likelihood that the network data 602 contains data associated with malicious or abnormal activity.

The prediction module 606 may generate an anomaly score 608 corresponding to each respective byte within the network data 602. In implementations, an anomaly score 608 is generated for each packet or session of data within the network data 602, such as by generating an average anomaly score 608 from the respective anomaly scores 608 for each byte included within the packet or session.

The prediction module 606 utilizes the anomaly scores 608 to classify portions of the network data 602 as malicious data 610. For instance, the prediction module 606 may incorporate a threshold value for anomaly scores such that any portions of the network data 602 that have an anomaly score exceeding the threshold value are classified and output as malicious data 610. The threshold value may be, for example, based on a percentile of anomaly scores (e.g., a threshold set at a value that is the 99′ percentile of all anomaly scores), may be a threshold value that is learned or adapted over time based on a supervised learning process, may be manually set according to results from a labeled test dataset, or so forth.

In this way, the anomaly prediction system 114 identifies malicious data 610 within the network data 602, without needing to understand in what way the malicious data 610 is malicious or how the malicious data 610 operates. Thus, the anomaly prediction system 114 is capable of identifying malicious data 610 corresponding to new or previously unseen threats, providing increased functionality beyond conventional techniques and providing protection against new or evolving threats.

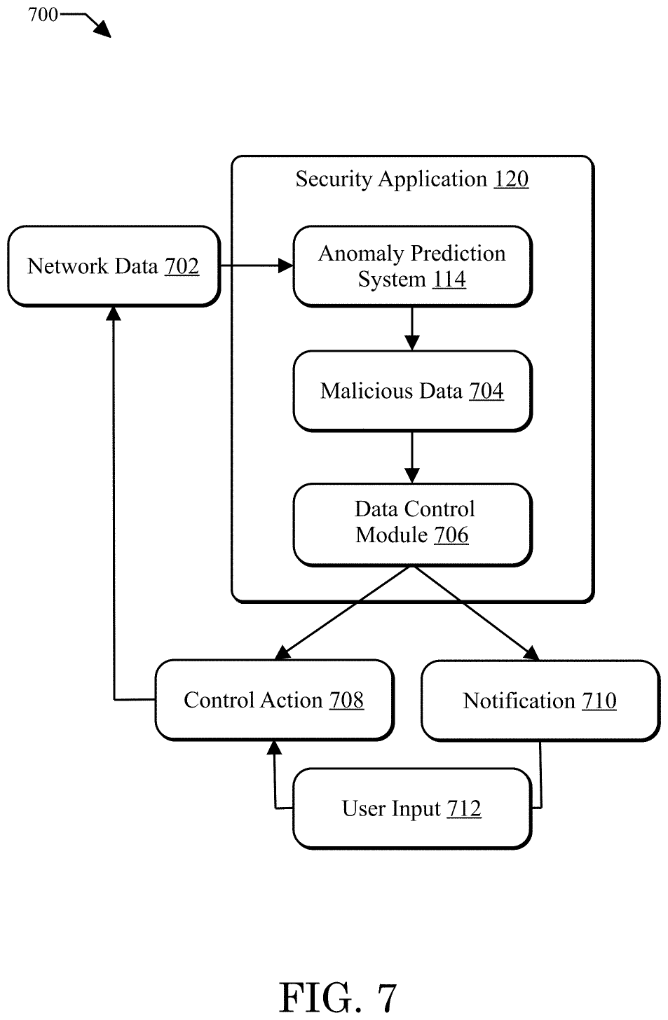

FIG. 7 depicts a system 700 showing an example security application processing pipeline of the security application 120 of FIG. 1 in greater detail to control anomalous or malicious data. The anomaly prediction processing pipeline begins with an input of network data 702 into the security application 120, which may be processed by the anomaly prediction system 114 to identify malicious data 704 such as described above with respect to FIG. 6.

In an example, the security application 120 is implemented on a client device (e.g., smart phone, personal computer, tablet, and so forth), a network device (e.g., a modem, router, and so forth), a hardware module connected to a network (e.g., a fob connected to a modem or router, a standalone hardware device connected to the network via a wired or wireless connection, and so forth), or a server device (e.g., a server providing cloud computing operations, a server facilitating network traffic, a server hosting online content), and so forth.

The security application 120 may collect packets from a network, extract information from the packets, and store the information for analysis by the anomaly prediction system 114. In implementations, the security application 120 stores the packets into a queue and is configured to feed the packets from the queue into the anomaly prediction system 114. The anomaly prediction system 114 processes the information as described above with respect to FIG. 6, and outputs the malicious data 704 that was included within the network data 702.

The security application 120 further includes a data control module 706, which is representative of functionality to control the malicious data 704 or enact actions relating to the malicious data 704. In implementations, the data control module 706 performs a control action 708. The control actions 708 may, for instance, be stored in a queue as pending actions, and the security application 120 may continually check the queue for pending actions to be performed.

The control action 708 may take a variety of forms. In implementations, the control action 708 includes blocking an IP address associated with the malicious data 704, blocking IP addresses associated with a region or country associated with the malicious data 704, blocking equipment corresponding to a MAC address associated with the malicious data 704, blocking specific network ports corresponding to identified network ports being attacked by the malicious data 704, or so forth. For example, the control action 708 may permanently block a particular IP address associated with the malicious data 704 while simultaneously temporarily blocking all IP addresses from a particular country of origin for the particular IP address, and also temporarily closing network ports that the malicious data 704 seeks to exploit. The control action 708 may also include generating a user notification 710 for communication to a client device. In implementations, multiple control actions 708 are performed. For example, a first control action 708 may pertain to generating a user notification, and a second control action may be performed responsive to receiving a response to the user notification.

The security application 120 may interface with various internal or external components and may expose APIs to be consumed, such as by a web interface, mobile applications, hardware alerts, and so forth. The information exposed by the APIs may include the pending actions, and may also include various other information. For example, the security application 120 may be configured to provide information via the notification 710 enabling display of various statistics, history of events, network devices and users, charts summarizing network health and activity, and so forth. The security application 120 may be configured to push information pertaining to the pending actions via the notification 710, such as to provide an alert of network breaches, malicious activities or events, and other information that may indicate an urgent or time-sensitive scenario, and may perform actions configured to grab a user's attention (e.g., sending an alert or notification to a UI on a client device, activating a chime or light on a hardware device, and so forth)

In implementations, the notification 710 is configured to cause the presentation of information in a user interface of a client device. This may include presenting remediation options to be selected by a user. Upon receiving a user input 712 selecting a remediation option, the security application 120 executes code associated with the option to effect the control action 708 to be performed upon the network data 702. For example, the security application 120 may alert a user, via a UI and responsive to identification of the malicious data 704, that there is malicious activity happening on their network. The security application 120 may further present, via the UI, a series of options for the user to select, such as to end all network activity, to remove network access for a particular user or device, to end a software process associated with the network activity, to block current and/or future network access for particular client devices, and so forth. As an example, upon a user selecting an option to remove network access for a device, the security application 120 may initiate a process to revoke access for the device to a network associated with the security application 120, such as by the security application 120 outputting information to a router of the network.

The security application 120 may incorporate various thresholds in relation to the output of the anomaly prediction system 114. For instance, the anomaly prediction system 114 may identify the malicious data 704 by assigning an anomaly score to particular bytes, packets, or sessions of data, and this anomaly score may be used to assign a classification confidence for the malicious data 704 representative of a confidence that the identified malicious data 704 is in fact malicious. In implementations, the security application 120 may initiate various behaviors based on the classification confidence meeting, exceeding, or failing to meet a threshold amount.

For instance, the security application 120 may include a first threshold and a second threshold, and may perform a first behavior if the classification confidence is below the first threshold, a second behavior if the classification confidence is between the first and second thresholds, and a third behavior if the classification confidence is above the second threshold. For example, the security application may perform no action if the classification confidence is below the first threshold (e.g., a threshold of 75% confidence), may send a notification 710 for display in a user interface if the confidence is at or above the first threshold but below a second threshold (e.g., a threshold of 90% confidence) to display information that a particular endpoint is exhibiting malicious behavior and provide an option for a user input 712 to disallow network communication for the particular endpoint, and may automatically disallow network communication for the particular endpoint if the classification confidence is at or above the second threshold. Disallowing network communication may include, for instance, isolating the endpoint from the network and disallowing communication with other endpoints internal or external to the network.

In this way, the security application 120 may utilize thresholds to allow for performance or automation of different actions based on a confidence in the classification, such as to automate tasks if the confidence is certain or near-certain and meeting a corresponding threshold, or request user input to initiate tasks if the confidence is less than certain or near-certain and meeting a corresponding threshold. Tasks that are automated based on the classification confidence may further include sending a notification to a client device for display in a user interface to inform a user that an action has been taken automatically.

The security application 120 may be further configured to communicate with or query an external source, such as a cloud server or other networked server, to retrieve any available system or model updates or patches, send telemetry data, or receive any other information or notification to be pushed to a client device associated with the security application 120. For example, the security application 120 may communicate the malicious data 704 to the digital analytics system 104 of FIG. 1 to be further analyzed such as to be used as input into another machine learning model for use in generating an updated input reconstruction module 118 with improved accuracy for future malicious activity and risk classification models. The security application 120 may additionally be configured to receive an updated anomaly prediction system 114 and/or input reconstruction module 118 from the digital analytics system 104, such as to receive a newer input reconstruction module that has be generated by the digital analytics system 104 more recently than the input reconstruction module 118 included within the security application 120.

In implementations, the control action 708 includes communicating information associated with the malicious data 704 to an external source, such as to facilitate cross knowledge sharing of the malicious data amongst different devices executing respective instances of the security application. For example, a security application 120 corresponding with a first device may communicate an IP address associated the malicious data 704 to a second device also running an instance of a security application 120, and both the first and second devices may then execute control actions 708 to block the IP address from accessing respective networks associated with the devices.

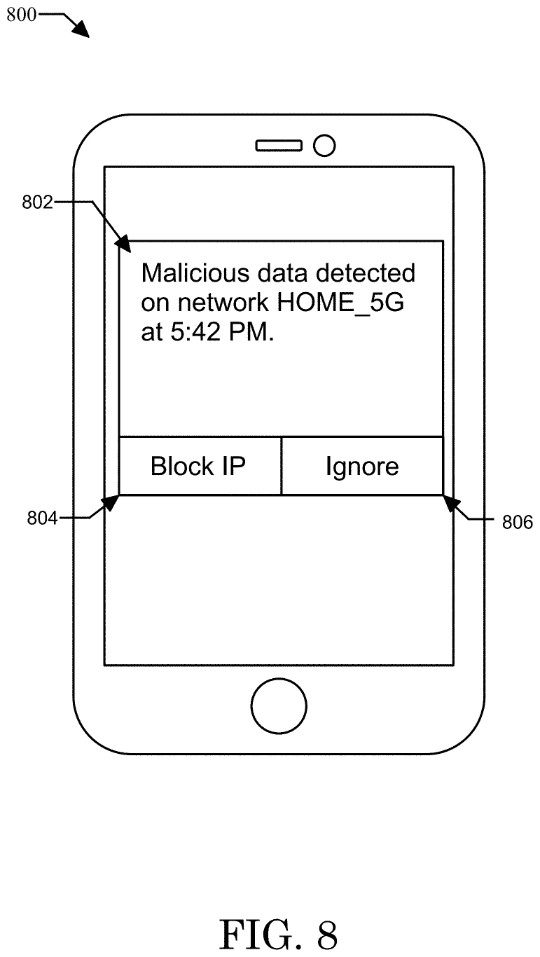

FIG. 8 illustrates an example scenario 800 depicting an example user interface on a client device. For instance, the example user interface displays a message corresponding to the notification 710 of FIG. 7. In this example, the user interface displays a message 802 that includes details pertaining to the identified malicious data 704, such as an indication that malicious data was detected along with the network the malicious data was detected on, and a time that the malicious data was detected. In this example, the user interface further includes buttons 804 and 806 prompting selection by a user of the client device. Button 804, for instance, may pertain to blocking an IP address associated with a source of the malicious data, and responsive to a user selecting the button 804, the security application 120 may initiate a control action 708 to remove all devices associated with the IP address from the network and to block future access to the network for the IP address. Button 806, for instance, may pertain to ignoring the notification, and responsive to a user selecting the button 806 the security application 120 may remove the corresponding malicious data 704 from all queues and not issue any control action 708 against the malicious data 704.

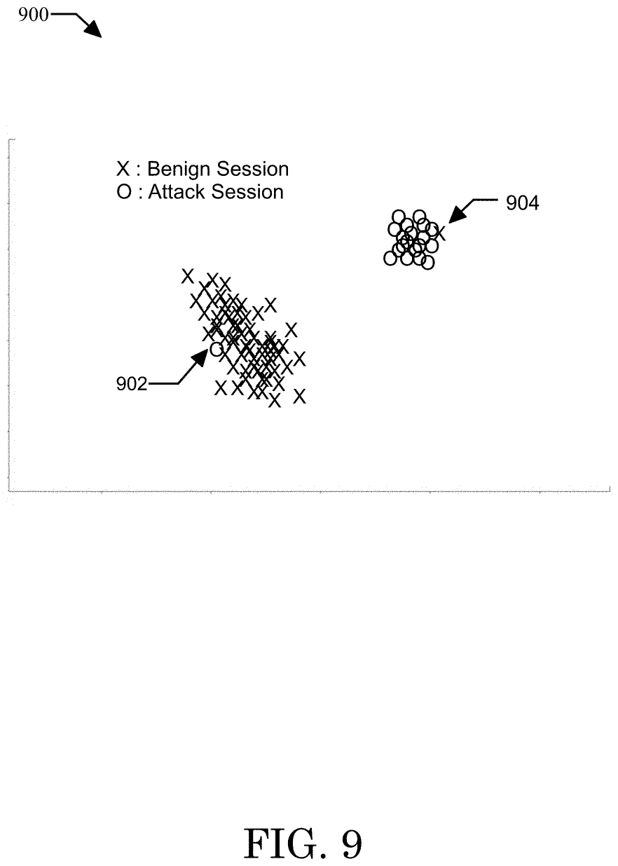

FIG. 9 illustrates an example scenario 900 depicting a 2D UMAP (Uniform Manifold Approximation and Projection) projection of session embeddings generated by the input reconstruction module 118. For example, the session embeddings may be the session vectors 520 as described above with respect to FIG. 5. Benign sessions are depicted with “X” marks, and attack sessions are depicted with “O” marks within the graph. In this example, benign sessions and attack sessions were determined by the anomaly prediction system 114 as described above. As shown, a cluster of attack sessions exists as an outlier from a cluster of benign sessions. In implementations, the anomaly prediction system 114 is configured to utilize the session embeddings directly to identify malicious data, such as by a direct comparison of values for a session embedding. These techniques may be utilized as an alternative method without utilizing the trained packet sequence decoder system 508 or the trained byte sequence decoder system 510 of FIG. 5, or may be utilized in addition to the techniques described above.

In implementations, the session embeddings are used to identify and correct false-positives and false-negatives within the anomaly prediction system 114. In the illustrated scenario 900, the anomaly prediction system 114 has incorrectly identified a session 902 as being an attack session. However, the session 902 was output as a false-positive, and is in actuality a benign session. The 2D UMAP projection and associated values, and/or the values of the session embeddings, may be utilized to identify a corresponding cluster of benign sessions and thereby identify the session 902 as a false-positive and alter the designation from an attack session to a benign session. Similarly, in the illustrated scenario 900, the anomaly prediction system 114 has incorrectly identified a session 904 as being a benign session. However, the session 904 was output as a false-negative, and is in actuality an attack session. The 2D UMAP projection and associated values, and/or the values of the session embeddings, may be utilized to identify a corresponding cluster of attack sessions and thereby identify the session 904 as a false-negative and alter the designation from a benign session to an attack session.

The anomaly prediction system 114 may utilize various techniques to identify clusters of session embeddings, such as connectivity-based clustering or hierarchical clustering, centroids-based clustering or partitioning methods, distribution-based clustering, density-based clustering or model-based methods, fuzzy clustering, constraint-based clustering or supervised clustering, and so forth. The anomaly prediction system 114 may thus generate clusters of session embeddings, and utilize the clusters to identify false-positives and false-negatives and thereby improve the overall accuracy of the anomaly prediction system 114. It is to be appreciated that while the example in FIG. 9 is illustrated as a 2D UMAP projection of the session embeddings to reduce the dimensionality of the session embeddings for ease of interpretation by human users, such dimensionality reduction is unnecessary to perform the techniques described above. For instance, clusters may be identified in multi-dimensional space (e.g., with a number of dimensions corresponding to the dimensionality of a session embedding) rather than in the two-dimensional space illustrated herein.

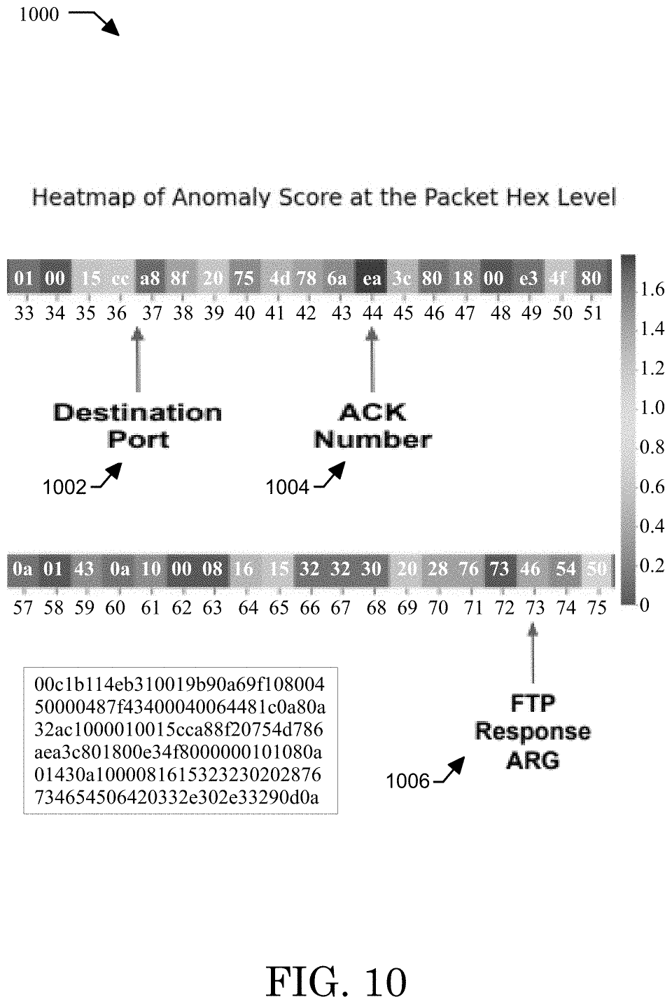

FIG. 10 illustrates an example scenario 1000 depicting a visualization of anomaly scores for bytes within a packet as determined by the anomaly prediction system 114. The anomaly scores may be output, for instance, as a notification 710 as described with respect to FIG. 7.

In this example, anomaly scores are determined for each respective byte within a packet, and individual bytes within the packet are identified as being anomalous. In the illustrated example, the session includes a brute force attack (FTP-Patator). The anomaly scores are presented at the hex level to illustrate which parts of the packet are anamolous, and may for instance be portrayed according to a spectrum of colors associated with the spectrum of anomaly scores. In this example, three locations within the packet are identified as being anomalous, illustrated as bytes 1002, byte 1004, and byte 1006. Bytes 1002 are associated with a destination port for the packet (e.g., bytes 36 and 37 when numbered sequentially from the beginning of the packet), byte 1004 is associated with an ACK number for the packet (e.g., byte 44 when numbered sequentially from the beginning of the packet), and byte 1006 is associated with an FTP response ARG (e.g., byte 73 when numbered sequentially from the beginning of the packet).

The identification of particular bytes of a packet that are anomalous or malicious enables the security application 120 to classify malicious data according to a type of attack. For example, the security application 120 may be configured to classify a packet with an anomalous destination port, ACK number, and FTP Response ARG as being an FTP-Patator brute force attack. As another example, the security application 120 might identify an unexpected FTP response in an unusual location within a packet, and leverage such insights to predict a brute force attack that utilizes the unexcepted FTP response. The data control module 706 may utilize these classifications of the malicious data in determining what control action 708 and/or notification 710 are to be generated. In implementations, malicious data 704 that corresponds to known attack types may have a control action 708 automatically generated and applied to the network data 702, while malicious data 704 that does not correspond to known attack types may prompt a user notification 710 requesting a user input 712 before generating a control action 708.

### Example Procedures

The following discussion describes techniques that may be implemented utilizing the previously described systems and devices. Aspects of the procedures may be implemented in hardware, firmware, software, or a combination thereof. The procedures are shown as sets of blocks that specify operations performed by one or more devices and are not necessarily limited to the orders shown for performing the operations by the respective blocks. In portions of the following discussion, reference will be made to FIGS. 1-10.

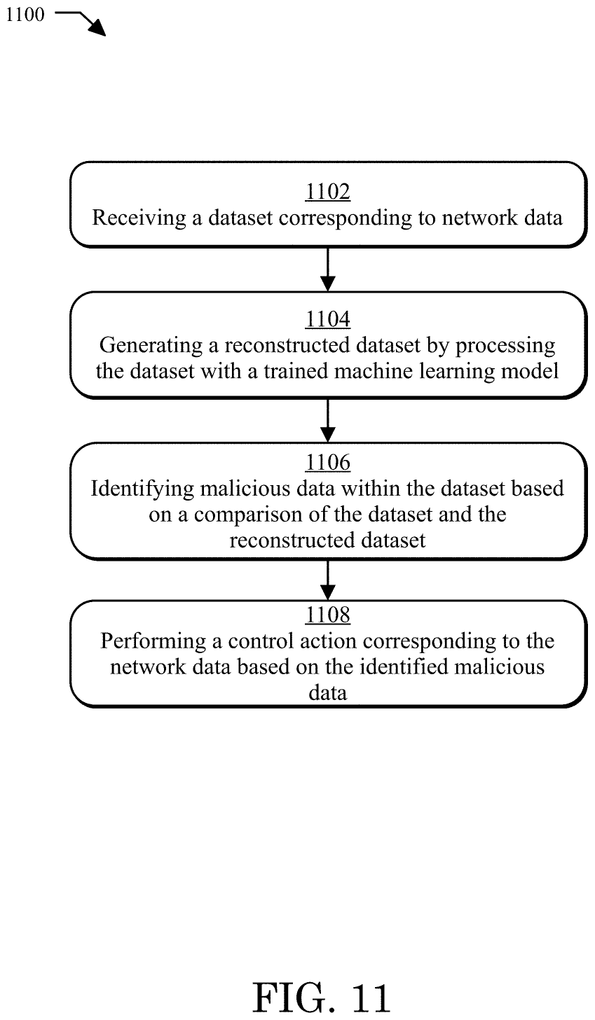

FIG. 11 depicts a procedure 1100 in an example implementation of network anomaly control. A dataset is received corresponding to network data (block 1102). In implementations, the dataset is network data collected from a network. The network data includes bytes of data with unknown characteristics, and may include both benign and malicious data. In an example, an edge device such as a modem or a router connected to a local network receives network data being communicated to, from, or within the local network. The edge device may include the security application 120 of FIG. 1, which monitors inbound network data that passes through the edge device into the local network as part of the edge device's normal operation. The security application may originate from a computing device external to the local network, however in this example the security application, once received, installed, or configured on the edge device, operates within the local network without further communication with the computing device external to the local network.

A reconstructed dataset is generated by processing the dataset with a trained machine learning model (block 1104). The machine learning model may be trained, for instance, by the machine learning module 116 as described above with respect to FIG. 4. In implementations, processing the dataset includes generating byte vectors by processing the bytes with an embedding lookup layer. The byte vectors are processed by a byte sequence encoder system to generate packet vectors, and the packet vectors are processed by a packet sequence encoder system to generate a session vector, as described above with respect to FIG. 5. The session vector is processed by a packet sequence decoder system to generate reconstructed packet vectors, and the reconstructed packet vectors are processed by a byte sequence decoder system to generate reconstructed byte vectors. In the ongoing example, the security application executed on the edge device processes the inbound network data to the local network to generated reconstructed byte vectors for the inbound network data.

Malicious data is identified within the dataset based on a comparison of the dataset and the reconstructed dataset (block 1106). In implementations, an anomaly score is generated for a byte based on a difference between values in the corresponding byte vector and the corresponding reconstructed byte vector. The byte is identified as being associated with malicious behavior based on the anomaly score exceeding a threshold value, as described above with respect to FIG. 6. In the ongoing example, the security application executed on the edge device identifies malicious data within the inbound network data to the local network. Such identification is performed, for instance, without communicating or reproducing the inbound network data outside of the local network, thus preserving data privacy for the local network.

A control action is performed corresponding to the network data based on the identified malicious data (block 1108). In implementations, the control action includes limiting network access to an entity associated with the malicious data, for instance to block an IP address associated with the malicious data, block equipment corresponding to a MAC address associated with the malicious data, and so forth. The control action may also include generating a user notification for communication to a client device, and additional control actions may be performed responsive to receiving a response to the user notification, such as described above with respect to FIG. 7. In the ongoing example, the security application executed on the edge device may manipulate the flow of inbound network data to block or otherwise redirect the malicious data within the inbound network data, thereby protecting the local network from malicious behavior.

Having discussed some example procedures, consider now a discussion of an example system and device in accordance with one or more implementations.

### Example System and Device

FIG. 12 illustrates an example system generally at 1200 that includes an example computing device 1202 that is representative of one or more computing systems and/or devices that may implement the various techniques described herein. This is illustrated through inclusion of the digital analytics system 104 and the security application 120. The computing device 1202 may be, for example, a server of a service provider, a device associated with a client (e.g., a client device), an on-chip system, and/or any other suitable computing device or computing system.

The example computing device 1202 as illustrated includes a processing system 1204, one or more computer-readable media 1206, and one or more I/O interface 1208 that are communicatively coupled, one to another. Although not shown, the computing device 1202 may further include a system bus or other data and command transfer system that couples the various components, one to another. A system bus can include any one or combination of different bus structures, such as a memory bus or memory controller, a peripheral bus, a universal series bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware element 1210 that may be configured as processors, functional blocks, and so forth. This may include implementation in hardware as an application specific integrated circuit or other logic device formed using one or more semiconductors. The hardware elements 1220 are not limited by the materials from which they are formed or the processing mechanisms employed therein. For example, processors may be comprised of semiconductor(s) and/or transistors (e.g., electronic integrated circuits). In such a context, processor-executable instructions may be electronically-executable instructions.

The computer-readable storage media 1206 is illustrated as including memory/storage 1212. The memory/storage 1212 represents memory/storage capacity associated with one or more computer-readable media. The memory/storage component 1212 may include volatile media (such as random access memory) and/or nonvolatile media (such as read only memory, Flash memory, optical disks, magnetic disks, and so forth). The memory/storage component 1212 may include fixed media (e.g., RAM, ROM, a fixed hard drive, and so on) as well as removable media (e.g., Flash memory, a removable hard drive, an optical disc, and so forth). The computer-readable media 1206 may be configured in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module”, “functionality”, and “component” as used herein generally represent software, firmware, hardware, or a combination thereof. The features of the techniques described herein are platform independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1202. By way of example, and not limitation, computer-readable media may include “computer-readable storage media” and “computer-readable signal media”.

“Computer-readable storage media” refers to media and/or devices that enable persistent and/or non-transitory storage of information in contrast to mere signal transmission, carrier waves, or signals per se. Thus, computer-readable storage media refers to non-signal bearing and non-transitory media. The computer-readable storage media includes hardware such as volatile and non-volatile, removable and nonremovable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, Flash memory, CD-ROM, DVD or other optical storage, hard disks, magnetic cassettes, magnetic tape, magnetic disk storage or other magnetic storage devices, or other storage devices, tangible media, or article of manufacture suitable to store the desired information and which may be accessed by a computer.

“Computer-readable signal media” refers to a signal-bearing medium that is configured to transmit instructions to the hardware of the computing device 1202, such as via a network. Computer-readable signal media may embody computer readable instructions, data structures, program modules, or other data in a modulated data signal, such as carrier waves, data signals, or other transport mechanisms. Computer-readable signal media also includes any information delivery media. The term “modulated data signal” means a signal that has one or more of its characteristics set or changed in such a manner as to encode information in the signal. By way of example, and not limitation, communication media includes weird media such as a wired network or direct-wired connection, and wireless media such as acoustic, RG, infrared, and other wireless media.

As previously described, hardware elements 1210 and computer-readable media 1206 are representative of modules, programmable device logic and/or fixed device logic implemented in a hardware form that may be employed in some embodiments to implement at least some aspects of the techniques descried herein, such as to perform one or more instructions. Hardware may include components of an integrated circuit or on-chip system, and application-specific integrated circuit, a field-programmable gate array, a complex programmable logic device, and other implementations in silicon or other hardware. In this content, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1210. The computing device 1202 may be configured to implement particular instructions and/or functions corresponding to the software and/or hardware modules. Accordingly, implementation of a module that is executable by the computing device 1202 as software may be achieved at least partially in hardware, e.g., through use of computer-readable storage media and/or hardware elements 1210 of the processing system 1204. The instructions and/or functions may be executable/operable by one or more articles of manufacture (for example, one or more computing devices 1202 and/or processing systems 1204) to implement techniques, modules, and examples described herein.

The techniques described herein may be supported by various configurations of the computing device 1202 and are not limited to the specific examples of the techniques described herein. This functionality may also be implemented all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 may include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 may abstract resources and functions to connect the computing device 1202 with other computing devices. The platform 1216 may also serve to abstract scaling of resources to provide a corresponding level of scale to encountered demand for the resources 1218 that are implemented via the platform 1216. Accordingly, in an interconnected device embodiment, implementation of functionality described herein may be distributed throughout the system 1200. For example, the functionality may be implemented in part on the computing device 1202 as well as via the platform 1216 that abstracts the functionality of the cloud 1214.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method for network anomaly control, implemented by at least one computing device, the method comprising:
receiving, by the at least one computing device, a dataset corresponding to network data;
generating, by the at least one computing device, a reconstructed dataset by processing the dataset with a trained machine learning model;
identifying, by the at least one computing device, malicious data within the dataset based on a comparison of the dataset and the reconstructed dataset; and
performing, by the at least one computing device, a control action corresponding to the network data based on the identified malicious data.

2. The method of claim 1, wherein the dataset includes a plurality of bytes, and the reconstructed dataset includes a plurality of reconstructed byte vectors.

3. The method of claim 1, wherein the generating the reconstructed dataset includes:
encoding the dataset into a session vector representative of the dataset; and
decoding the session vector into a reconstructed dataset.

4. The method of claim 1, wherein the dataset includes a plurality of bytes, and wherein the generating the reconstructed dataset includes:
generating a plurality of byte vectors, each respective one of the plurality of byte vectors corresponding to a respective one of the plurality of bytes;
encoding the plurality of byte vectors into a plurality of packet vectors;
encoding the plurality of packet vectors into a session vector;
decoding the session vector into a plurality of reconstructed packet vectors; and
decoding the plurality of reconstructed packet vectors into a plurality of reconstructed byte vectors.

5. The method of claim 1, wherein the identifying malicious data within the dataset includes generating at least one anomaly score based on a difference between the dataset and the reconstructed dataset.

6. The method of claim 4, wherein the identifying malicious data within the dataset includes generating, for each respective one of the plurality of byte vectors, an anomaly score based on a difference between the respective one of the plurality of byte vectors and a corresponding respective one of the plurality of reconstructed byte vectors.

7. The method of claim 5, wherein the identifying malicious data within the dataset includes identifying at least one anomaly score that equals or exceeds a threshold value.

8. The method of claim 1, wherein the control action includes communicating, to a client device, a notification configured for display in a user interface of the client device.

9. The method of claim 8, wherein the notification includes at least one prompt; and responsive to receiving a communication indicating a user selection of the prompt, performing at least one more control action.

10. The method of claim 1, wherein the control action includes blocking communication of data associated with the identified malicious data.

11. The method of claim 1, wherein the trained machine learning model corresponds to a neural network including:
at least one layer for generating a session vector representative of the network data by encoding the network data; and
at least one layer for generating the reconstructed dataset by decoding the session vector.

12. The method of claim 1, wherein the trained machine learning model corresponds to a neural network including:
at least one layer for generating packet vectors based on input byte vectors;
at least one layer for generating a session vector based on the packet vectors;
at least one layer for generating reconstructed packet vectors based on the session vector; and at least one layer for generating reconstructed byte vectors based on the reconstructed packet vectors.

13. At least one computing device in a digital medium environment for network anomaly control, the at least one computing device including a processing system and at least one computer-readable storage medium, the at least one computing device comprising:
at least one byte sequence encoding layer of a neural network, the at least one byte sequence encoding layer configured to convert a plurality of byte vectors associated with network data into a plurality of packet vectors, each respective one of the packet vectors representative of two or more of the byte vectors;
at least one packet sequence encoding layer of the neural network, the at least one packet sequence encoding layer configured to convert the plurality of packet vectors into a session vector;
at least one packet sequence decoding layer of the neural network, the at least one packet sequence decoding layer configured to convert the session vector into a plurality of reconstructed packet vectors corresponding to the plurality of packet vectors; and
at least one byte sequence decoding layer of the neural network, the at least one byte sequence decoding layer configured to convert the plurality of reconstructed packet vectors into a plurality of reconstructed byte vectors, each respective one of the reconstructed byte vectors corresponding to a respective one of the plurality of byte vectors.

14. The at least one computing device of claim 13, wherein the neural network further includes at least one embedding lookup layer configured to convert a plurality of bytes in the network data into the plurality of byte vectors.

15. The at least one computing device of claim 13, wherein the at least one computing device further includes a prediction module configured to generate an anomaly score for a byte within the network data based on a comparison of a respective byte vector corresponding to the byte and a respective reconstructed byte vector corresponding to the byte.

16. The at least one computing device of claim 15, wherein the at least one computing device further includes a data control module configured to perform a control action on the network data responsive to identifying malicious data in the network data based on the anomaly score.

17. An edge device comprising:
one or more processors;
a network interface configured to receive communication via a local network; and
one or more computer-readable storage media storing processor-executable instructions that, responsive to execution by the one or more processors, cause the system to perform operations including:
monitoring inbound network data communicated to the local network;
generating reconstructed network data corresponding to the network data by processing the network data with a trained machine learning model;
identifying malicious data within the network data based on a comparison of the dataset and the reconstructed dataset; and
performing a control action corresponding to the network data based on the identified malicious data.

18. The edge device of claim 17, wherein the edge device is at least one of a modem and a router configured to relay the network data within the local network.

19. The edge device of claim 18, wherein:
the control action includes communicating a notification to a client device connected to the local network, the notification configured to cause display of a message in a user interface of the client device, the message including a prompt configured for selection by a user of the client device; and
the operations further including: responsive to receiving a response from the client device, performing another control action based on the communication indicating selection of the prompt.

20. The edge device of claim 17, wherein the trained machine learning model is received from a computing device external to the local network and wherein the network data is not communicated to the computing device.
